(19) United States
(12) Patent Application Publication
(10) Pub. No.: US 2009/0184102 A1
(43) Pub. Date: Jul. 23, 2009

(54) Beverage Heating System

(76) Inventors: Leslie L. Parker, JR., Colerain, NC (US); Joan Parker, JR., Colerain, NC (US)

Correspondence Address: GLOBAL PATENTS/RANDY W. TUNG, ESQ, 838 W. LONG LAKE, SUITE 120, BLOOMFIELD HILLS, MI, 48302, US

(21) Appl. No.: 12/017,013

(22) Filed: Jan. 19, 2008

(51) Int. Cl. H05B 1/00; H05B 3/00

(52) U.S. Cl. 219/387; 219/436

(57) ABSTRACT

A beverage heating system is disclosed. An illustrative embodiment of the beverage heating system includes a recharge base; a mug having a mug base removably seated on the recharge base, a mug body extending from the mug base and a mug handle extending from the mug body; a heating compartment provided in the mug base; at least one heating element provided in the heating compartment; and a power source connected to the at least one heating element.

### FIELD

The present invention relates to beverage mugs. More particularly, the present invention relates to a beverage heating system having a detachable mug.

### BACKGROUND

Many persons enjoy drinking heated beverage such as coffee in transit between home and office or other location. Away from the home, however, there typically lacks a suitable heating mechanism for reheating the beverage contents of the container in which the beverage is carried. Therefore, a beverage heating system having a detachable mug is needed.

### SUMMARY

The present invention is generally directed to a beverage heating system. An illustrative embodiment of the beverage heating system includes a recharge base; a mug having a mug base removably seated on the recharge base, a mug body extending from the mug base and a mug handle extending from the mug body; a heating compartment provided in the mug base; at least one heating element provided in the heating compartment; and a power source connected to the at least one heating element.

### BRIEF DESCRIPTION OF THE DRAWINGS

The invention will now be described, by way of example, with reference to the accompanying drawings, in which:

FIG. 1 is a perspective view, partially in section, of an illustrative embodiment of the beverage heating system;

FIG. 2 is an exploded perspective view, partially in section, of an illustrative embodiment of the beverage heating system, with a mug element detached from a rechargeable battery element of the beverage heating system;

FIG. 3 is a sectional view, taken along section lines 3-3 in FIG. 1, of an illustrative embodiment of the beverage heating system; and

FIG. 4 is a block diagram which illustrates interconnection of various functional elements of an illustrative embodiment of the beverage heating system.

FIG. 5 is a perspective view of the rechargeable battery poisoned over a battery charger.

### DETAILED DESCRIPTION

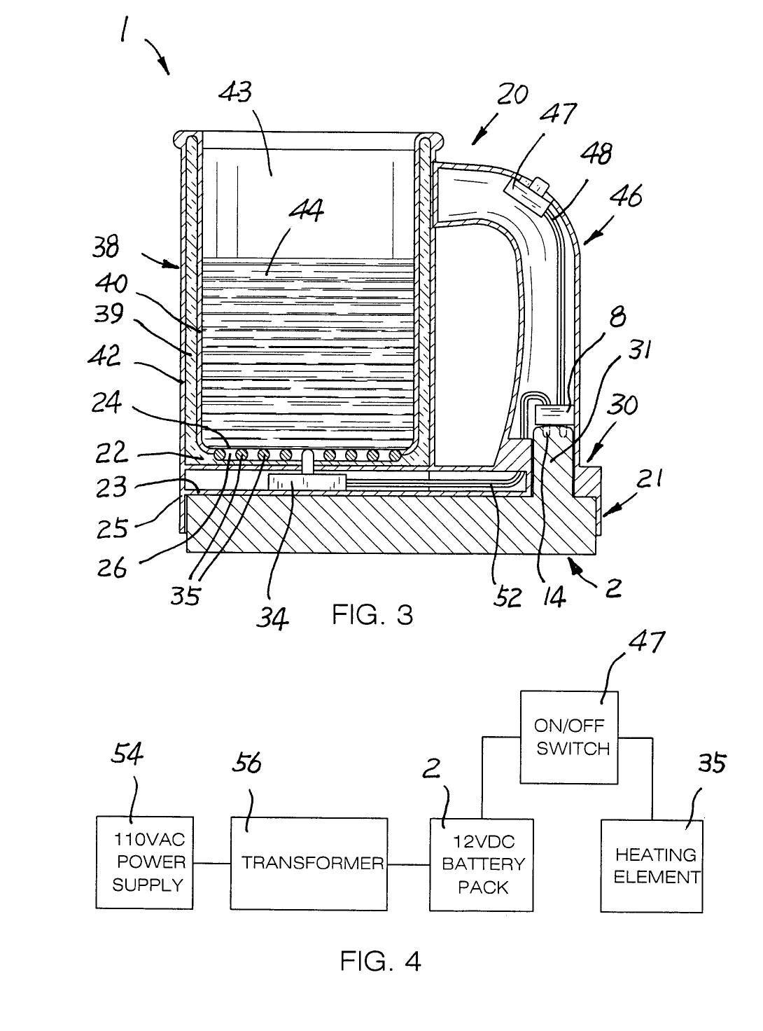

Referring to the drawings, an illustrative embodiment of the beverage heating system, hereinafter system, is generally indicated by reference numeral 1. The system 1 includes a rechargeable battery 2 and a mug 20 which is detachably supported by the rechargeable battery 2. As will be hereinafter described, the mug 20 can be detachably placed on the rechargeable battery 2 to heat liquid beverage contents 44 (FIG. 3) in the mug 20. The mug 20 is then removed from the rechargeable battery 2 for drinking of the beverage contents 44 from the mug 20.

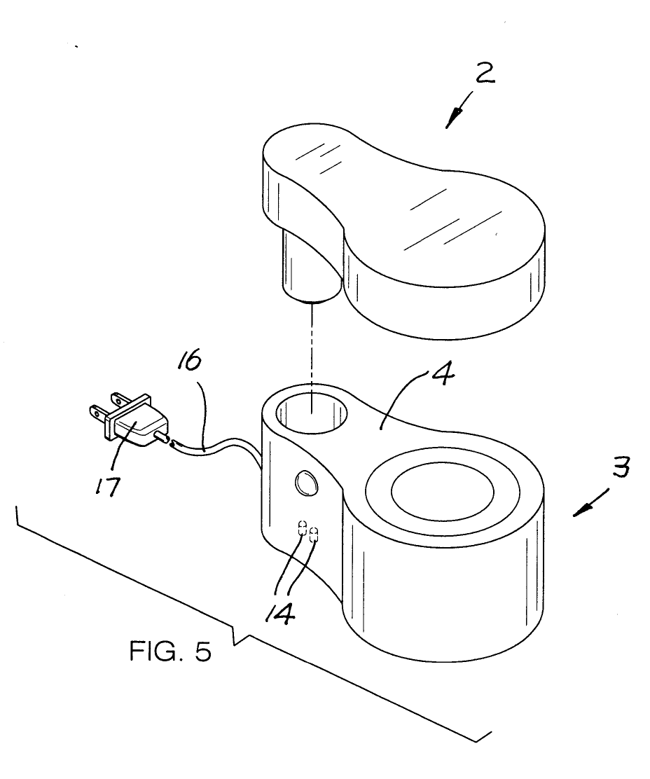

The rechargeable battery 2 may be recharged in a charger portion 3, shown in FIG. 5, which is typically circular but may be any desired alternative shape. The charger base 3 has a support surface 4. A pair of spaced-apart electrical contacts 14, which will be hereinafter described, extends from the base surface. A power cord 16, which terminates in a plug 17, extends from the charger base 3 and is electrically connected to the electrical contacts 14. The plug 17 of the power cord 16 is adapted for connection to a power supply 54 (FIG. 4) such as a 110V household electrical outlet (not shown), for example.

The mug 20 includes a mug base 21 having a heating compartment 22, which is typically circular, and a handle base 30 which is typically elongated and extends from the heating compartment 22. As shown in FIG. 3, the heating compartment 22 includes a bottom panel 23, a top panel 24 which is spaced-apart from the bottom panel 23 and a wall 25 which connects the top panel 24 to the bottom panel 23. The top panel 24 is a heat-conductive material. A heating compartment interior 26 is defined by the bottom panel 23, the top panel 24 and the wall 25. The handle base 30 includes a battery compartment 31 which may communicate with the heating compartment interior 26 of the heating compartment 22. A pair of spaced-apart contact openings (not shown) is provided in the bottom panel 23 portion of the handle base 30 for purposes which will be hereinafter described.

As further shown in FIG. 3, a heating element base 34 is provided in the heating compartment interior 26 of the heating compartment 22. At least one heating element 35 extends from the heating element base 34, inside the heating compartment interior 26. A rechargeable battery pack 2, which may be a 12V, 18V or 24V DC battery pack, for example, is provided in the battery compartment 31 of the handle base 30. The heating element base 34 is connected to the battery 50 through wiring 52. When the mug 20 is seated on the rechargeable battery 2, the battery 2 is disposed in electrical contact with the electrical contacts 14, which extend from the base extension 8.

The mug 20 further includes a mug body 38 which is provided on the heating compartment 22 of the mug base 21. A mug wall 42, which is typically cylindrical, extends from the mug bottom 41. The mug bottom 41 and mug wall 40,42 define a mug interior 43 which is adapted to contain the beverage 44. The mug bottom 41 and the mug wall 42 of the mug body 38 typically includes an insulation layer 39 and outer and inner casing layers 40 which enclose the insulation layer 39.

A mug handle 46 extends between the handle base 30 of the mug base 21 and the mug body 38 of the mug 20. A power switch 47 is provided on the mug handle 46. The power switch 47 is electrically connected to the rechargeable battery 2 typically via wiring 48. As shown in FIG. 4, a step-down transformer 56 is typically electrically connected between the power supply 54 and the rechargeable battery 2. The transformer 56 is typically exterior to the rechargeable battery 2 and may be incorporated into the power cord 16. The power switch 47 is electrically connected between the rechargeable battery 2 and the at least one heating element 35. Accordingly, when the plug 17 of the power cord 16 is connected to the power supply 54, electrical power is distributed from the power supply 54, through the transformer 56 and to the rechargeable battery 2 to recharge the batteries in the rechargeable battery 2, as deemed necessary. The power switch 47 can be selectively manipulated to facilitate flow of electrical power from the rechargeable battery 2 to the at least one heating element 35 as desired to facilitate heating of the mug 20 when the mug 20 is seated on the rechargeable battery 2.

In typical use of the system 1, as shown in FIG. 5, the plug 17 on the power cord 16 is connected to the power supply 54. The rechargeable battery 2 is seated on the charger base 3. The rechargeable battery 2 is recharged, as necessary, through the transformer 56.

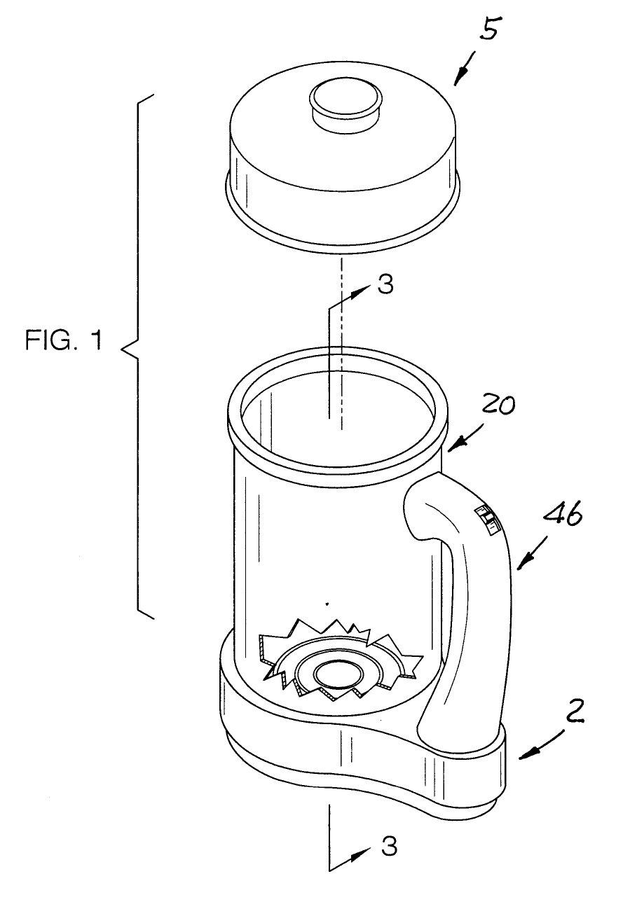

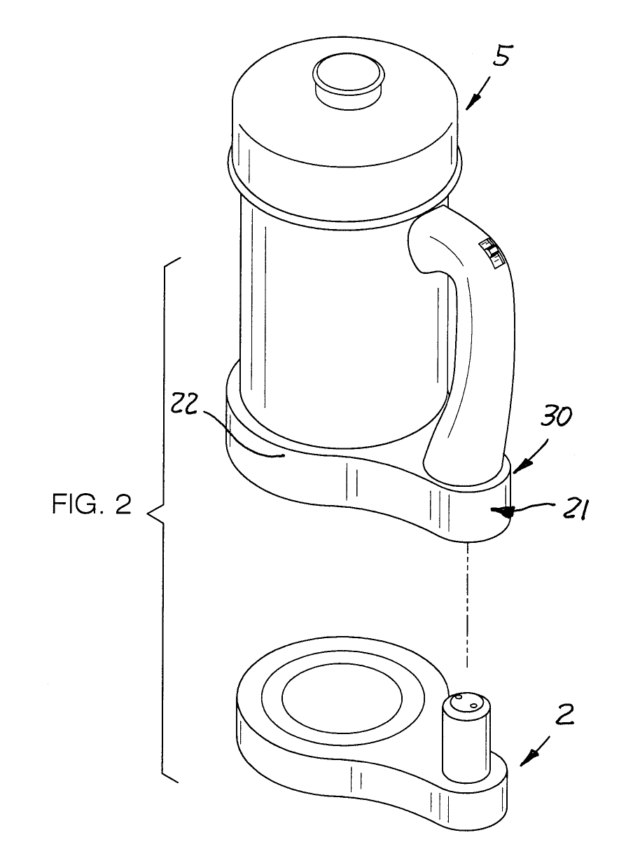

The mug 20 can be removed from the rechargeable battery 2 typically by grasping the mug handle 46. A heated beverage 44 (FIG. 3), such as coffee, for example, is placed in the mug interior 43 of the mug 20. The beverage 44 can be heated or warmed, as deemed necessary, by manipulation of the power switch 47. Accordingly, electrical power flows from the rechargeable battery; through the wiring 52 and heating element base 34, respectively; and to the at least one heating element 35. The at least one heating element 35 heats the beverage 44 in the mug interior 43 of the mug 20 through the top panel 24 of the heating compartment 22 and the mug bottom 41 of the mug body 38. The at least one heating element 35 can be selectively turned off by manipulation of the power switch 47. When recharging the rechargeable battery 2 is necessary, the battery 2 again placed on the recharge base 2. The mug 20 may be optionally equipped with cap 5, as shown in FIG. 1.

While the preferred embodiments of the invention have been described above, it will be recognized and understood that various modifications can be made in the invention and the appended claims are intended to cover all such modifications which may fall within the spirit and scope of the invention.

What is claimed is:

1. A beverage heating system, comprising:
a rechargeable battery;
a mug having a mug base removably seated on said rechargeable battery, a mug body extending from said mug base and a mug handle extending from said mug body;
a heating compartment provided in said mug base;
at least one heating element provided in said heating compartment; and
a power source connected to said at least one heating element.

2. The system of claim 1 further comprising a power switch provided on said mug handle and connected to said power source.

3. The system of claim 1 wherein said power source comprises a rechargeable battery pack.

4. The system of claim 3 further comprising a pair of electrical contacts provided on charger base and disposed in electrical communication with said rechargeable battery and a power cord electrically connected to said pair of electrical contacts.

5. The system of claim 4 wherein said charger base comprises a generally circular main base portion and a base extension extending from said main base portion.

6. The system of claim 1 wherein said mug body comprises a mug bottom and a generally cylindrical mug wall extending from said mug bottom.

7. The system of claim 6 wherein said mug bottom and said mug wall each comprises an insulation layer and casing layers enclosing said insulation layer.
